(19) United States
(12) Patent Application Publication
(10) Pub. No.: US 2021/0389056 A1
(43) Pub. Date: Dec. 16, 2021

(54) LOW-COST, MODULAR HIGH-TEMPERATURE THERMAL ENERGY STORAGE SYSTEM

(71) Applicant: KHALIFA UNIVERSITY OF SCIENCE AND TECHNOLOGY, Abu Dhabi (AE)

(72) Inventors: Nicolas CALVET, Abu Dhabi (AE); Jean-Francois HOFFMANN, Abu Dhabi (AE); Djawed BELASRI, Abu Dhabi (AE)

(21) Appl. No.: 17/279,401

(22) PCT Filed: Oct. 29, 2019
(86) PCT No.: PCT/IB2019/059259

§ 371 Date: Mar. 24, 2021

Related U.S. Application Data
(60) Provisional application No. 62/752,403, filed on Oct. 30, 2018.

(51) Int. Cl. F28D 20/00

(52) U.S. Cl. CPC F28D 20/0056

(57) ABSTRACT

There is provided a modular and high-temperature thermal energy storage system, which withstands temperature and mechanical conditions. The disclosed thermal energy storage system comprises a thermal energy storage assembly to adapt to storage capacity requirements of an energy consumer comprises a plurality of thermal energy storage modules are stacked on top of each other to increase energy storage capacity, wherein the stack of thermal energy storage modules acts as a single thermal energy storage unit. Also disclosed is a regenerator manufactured using a plurality of thermal energy storage modules comprises a first chamber to store heat from a hot source resulting in charging operation, and a second chamber to transfer the stored heat to air resulting in discharging. A parallel configuration of the thermal energy storage modules allows for simultaneous charging and discharging operations.

### CROSS-REFERENCE TO RELATED APPLICATIONS AND PRIORITY

This patent application claims priority from PCT Patent Application No. PCT/IB2019/059259 filed Oct. 29, 2019, which claims priority from U.S. Provisional Patent Application No. 62/752,403 filed Oct. 30, 2018. Each of these patent applications are herein incorporated by reference in their entirety.

### FIELD OF THE INVENTION

The present invention relates to the field of thermal energy storage systems, and more particularly to a modular and high-temperature thermal energy storage system.

### BACKGROUND OF THE INVENTION

According to the US Department of Energy, the industrial sector accounts for about one-third of the world total energy consumed and consequently is responsible for about one-third of fossil-fuel-related greenhouse gas emissions. It is estimated that somewhere between 20% to 50% of industrial energy input is lost as waste heat in the form of hot exhaust gases. As the industrial sector continues efforts to improve its energy efficiency, recovering heat losses provides an attractive opportunity for an emission-free and cheaper energy resource. Waste heat recovery (WHR) methods include heat collection and transport using heat transfer fluids gases and/or liquids, and heat production for process heat, power generation, or cooling.

To transfer heat from continuous exhaust gases at high temperature (>1000° C.), some heat exchangers and regenerators (functioning as buffer storage) technical solutions have been developed. The regenerator consists of two thermal chambers through which hot and cold airs flow alternately. The two chambers are used in the way that one stores heat from the exhaust gases and the second transfers heat to the combustion air (efficiency of a burner increases with temperature of the combustion air). For intermittent exhaust gases, like batch processes, the unique solution is to use a thermal energy storage (TES) system to facilitate continuous power generation or process heat re-use. Major drawbacks of regenerators and TES systems used in heavy industry are the large size and capital costs. The previous technologies use exhaust gases or air because conventional thermal oil or molten salt have a limited temperature range (<400° C. for synthetic oil and <600° C. for molten salt) and present significant drawbacks (hazard classification, flammability), which limit their applicability in heavy industry.

Energy supply has always been a major issue, all the more so now that fossil fuels are becoming increasingly scarce, and with rising concerns about global warming. One solution that has emerged is the development of renewable energy technologies. Renewable energy sources are theoretically inexhaustible, so they can supply the global population for, at least, a very long time. Concentrated solar power (CSP) is one of the most promising renewable energy technologies, since solar radiation is available worldwide, and thanks to thermal energy storage. Unlike photovoltaic technology, which produces electricity directly from sunlight, CSP first produces heat that can be directly used or transformed into electricity thanks to a Rankine power cycle. Since thermal energy is easier to store compared to electricity, it is theoretically possible to overcome problems of energy source intermittency, generate electricity at a constant power, and increase plant capacity factor.

Usually, commercial CSP plants use a two-tank molten salt system to store thermal energy. When the solar resource exceeds the power block needs, a part of the heat transfer fluid, generally synthetic oil, is diverted into a heat exchanger to transfer the heat to a more appropriate fluid for energy storage, generally molten salts. The latter is then stored in a tank called the hot tank. When there is a need for more energy than the solar radiation can provide, because of clouds or low sun elevation, the thermal energy storage fluid discharged the energy stored. To do so, it flows through the same heat exchanger and then is stored in another tank called the cold tank. This solution is almost always chosen because of its effectiveness and easiness to handle. Although two tanks are used, the heat transfer fluid volume is roughly equal to the volume of one tank only, which means that one tank may be removed to reduce the TES unit cost. Indeed, this TES technology represents a high initial investment, between 15 and 20% of the total cost of the CSP plant, it is classified as hazardous (SEVESO) in Europe and has a limited working temperature range below 600° C.

One solution for both renewable energy and heavy industry sectors is to use a thermocline TES system with solid filler materials and a gas as heat transfer fluid. The thermocline system consists of a single tank, with a thermal separation dissociating the hot and cold regions. The tank has two different inlets according to the operating mode. Hot fluid, coming from the heat source enters the hot part of the tank during the charge mode and displaces progressively the thermal separation zone meanwhile cold fluid is extracted from the cold part of the tank. A thermal gradient called thermocline is thus created in the TES system, allowing thermal separation but expanding within the tank over time. The term thermocline comes from the oceanographic vocabulary. It represents the thermal transition zone between the upper and the deep waters. On either side of the thermocline zone, the temperatures are nearly identical whereas the temperature range in the thermocline itself is wide. With low thermal storage capacity heat transfer fluids, such as air, a solid storage matrix is installed in the single tank. This type of storage system is called thermocline thermal energy storage with solid materials. This system offers significant possibilities to reduce the installation cost compared to the two-tank molten salt technology and it is the solution for high temperature storage.

However, some elements of the thermocline TES system using solid filler materials lead to limitations preventing its deployment in the industry or renewable energies sector. First of all, the combination of a solid matrix and a low thermal capacity fluid has a direct impact on the outlet temperature and pressure drops of the TES system. In order to maximize the efficiency of an industrial process, the fluid temperature discharged from a TES system has to be as steady as possible. The outlet temperature of a standard thermocline TES system decreases gradually over time until the cut-off temperature, defined by the upstream process, is reached. A major temperature drop would impact directly the process and the TES system yields. The yield of the TES system is the relation between the thermal energy extracted from the storage system during discharge (i.e. the energy that the final user receives) and the thermal energy initially stored in the storage system. The pressure drops are directly linked to the solid material geometry used and the size of the tank. For large scale TES system, the pressure drops may be so high that they would lead to larger investments for the ventilation system and parasitical electrical overconsumption. Secondly, adding a solid matrix creates mechanical constraints. In order to get a proper diffusion of the heat transfer fluid in the lowest part of a vertical tank, it is necessary to install supporting beams to bear all the solid materials weight. The combination of a large scale TES single-tank and high temperature can lead to significant extra expenditures. In the case of a solid filler materials matrix (e.g., spheres, Raschig rings, or natural rocks), mechanical stress or bursting of the tank's walls may happen. Indeed, vertical-cylindrical tank expands when the temperature rises (increasing diameter). The space created is then filled by the granular materials, generally by settlement. Consequently, when the temperature decreases, a new mechanical constraint is created on the walls. This phenomenon is called thermal ratcheting. Finally, despite a decrease of the cost from a two-tank to a single-tank TES system, the thermocline TES system is not yet enough competitive to be deployed in the industry sector. In addition of a specific design for each configuration, the structural elements (tank and insulation material) are costly as they have to withstand the temperature and, more importantly, the mechanical conditions due to the solid matrix.

Accordingly, there exists a need to provide a low cost thermal energy storage system which withstands temperature and mechanical conditions.

### SUMMARY OF THE INVENTION

Therefore it is an object of the present invention to provide a modular and high-temperature thermal energy storage system which withstands temperature and mechanical conditions.

The present invention involves a thermal energy storage module or regenerator with a constant outlet temperature comprising a fluid inlet and a fluid outlet, a thermal storage matrix composed of solid filler materials to store energy from a hot source and a thermal insulation.

In an embodiment of the present invention, a plurality of metallic openings on the fluid inlet and fluid outlet of the thermal energy storage module or regenerator, allow heat transfer fluid to flow in a first direction or in a second direction opposite to the first direction.

In another embodiment of the present invention, the thermal energy storage module or regenerator further comprises a casing which preserves structural rigidity of the thermal energy storage module or regenerator.

In another embodiment of the present invention, the casing of the thermal energy storage module or regenerator is made of a rigid and temperature resistant material comprising steel or ceramic.

In another embodiment, the thermal storage matrix of the thermal energy storage module or regenerator accumulates thermal energy from the heat transfer fluid during a charge and restores thermal energy to the heat transfer fluid during a discharge.

In another embodiment of the present invention, the thermal storage matrix of the thermal energy storage module or regenerator comprises filler materials with controlled or non-controlled geometry.

In another embodiment of the present invention, the thermal insulation, mounted around the thermal storage matrix, ensures high thermal energy storage efficiency by limiting heat exchange between a plurality of thermal energy storage modules and further maintains structural rigidity of the thermal storage matrix.

In another embodiment of the present invention, the thermal energy storage module or regenerator further comprises a permeable wall located at first and second ends of the thermal storage matrix, to allow entry of heat transfer fluid through the first end and exit of heat transfer fluid from the second end of the thermal storage matrix.

In another embodiment of the present invention, the permeable wall of the thermal energy storage module or regenerator is made of a temperature resistant material comprising steel or ceramic.

In another embodiment, the thermal insulation of the thermal energy storage module or regenerator comprises rock wool.

As another aspect of the present invention, a process of charging and discharging operations of a thermal energy storage system is disclosed, wherein charging results in a cold fluid being extracted from a bottom opening of the thermal energy storage system, and discharging results in heat transfer fluid at high temperature being extracted from a top opening of the thermal energy storage system.

In another embodiment of the present invention, a temperature level of the heat transfer fluid is at least 200° C.

In another embodiment of the present invention, the charging operation comprises allowing entry of a hot fluid through the top opening of the thermal energy storage system, and creating a thermocline zone which moves a thermal gradient through the thermal storage matrix from a first end to a second end opposite to the first end.

In another embodiment of the present invention, the discharging operation comprises inserting air at ambient temperature through the bottom opening of the thermal energy storage system, resulting in moving a thermal gradient through the thermal storage matrix from a second end to a first end opposite to the second end.

In another embodiment of the present invention, the thermal energy storage system further comprises a ventilation system mounted at the bottom opening of the thermal energy storage system, to compensate for a pressure drop and to create a gas flow throughout the thermal energy storage system.

As another aspect of the present invention, a thermal energy storage assembly capable of adapting to variable storage capacity requirements comprises a plurality of thermal energy storage modules stacked on top of each other to increase energy storage capacity, wherein the stack of thermal energy storage modules acts as a single thermal energy storage unit.

In another embodiment of the present invention, the thermal energy storage modules of the thermal energy storage assembly are connected in a series configuration to reduce relative thickness of a thermocline zone of the whole thermal energy storage assembly, thereby increasing charge and discharge efficiencies.

In another embodiment of the present invention, the thermal energy storage modules of the thermal energy storage assembly are connected in a parallel configuration to reduce fluid velocity in each module line, thereby reducing pressure losses.

In another embodiment of the present invention, the thermal energy storage assembly is placed on an insulated concrete pad and an external metallic shell wraps the thermal energy storage assembly.

As another aspect of the present invention, a method of manufacturing a regenerator using a plurality of thermal energy storage modules is disclosed, the method comprising connecting a plurality of thermal energy storage modules between fluid inlet or outlet modules, installing a thermal insulation around the plurality of thermal energy storage modules and the fluid inlet or outlet modules and wrapping an external metallic shell around the thermal insulation, wherein the external metallic shell protects the thermal insulation.

In another embodiment of the present invention, the regenerator further comprises a first chamber to store heat from a hot source resulting in charging operation, and a second chamber to transfer the stored heat to air resulting in discharging.

In another embodiment of the present invention, a parallel configuration of the thermal energy storage modules of the regenerator reduces pressure losses by reducing fluid velocity in each storage module, and allows for simultaneous charging and discharging operations.

In another embodiment of the present invention, the regenerator is placed on an insulated concrete pad and an external metallic shell wraps the regenerator.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which—

FIG. 1 shows a 3-D isometric view of the thermal energy storage module in accordance with the present invention.

FIG. 2 displays schematic drawings of the side and top views of the thermal energy storage module in accordance with the present invention.

FIG. 3 denotes charge and discharge operation schemes of the thermal energy storage module in accordance with the present invention.

FIG. 4 illustrates a stack of thermal energy storage modules.

FIG. 5A depicts the charging operation of the thermal energy storage module in accordance with the present invention.

FIG. 5B depicts the discharging operation of the thermal energy storage module in accordance with the present invention.

FIG. 6A shows a series configuration of the modules in the thermal energy storage system in accordance with the present invention.

FIG. 6B shows a parallel configuration of the modules in the thermal energy storage system in accordance with the present invention.

FIG. 7 illustrates the regenerator configuration in accordance with the present invention.

FIG. 8 illustrates the thermally insulated regenerator configuration in accordance with the present invention.

### DETAILED DESCRIPTION OF THE INVENTION

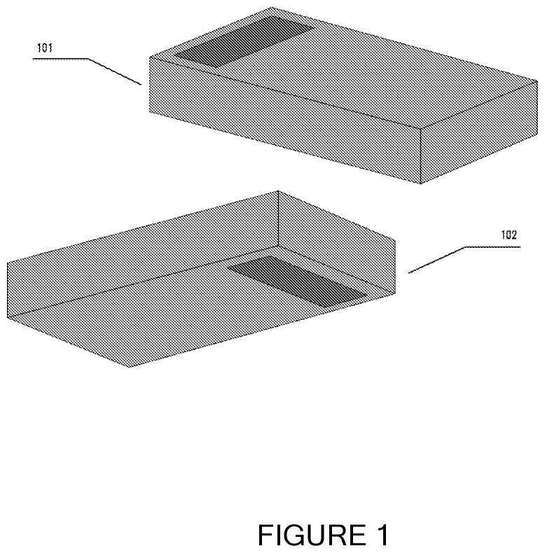

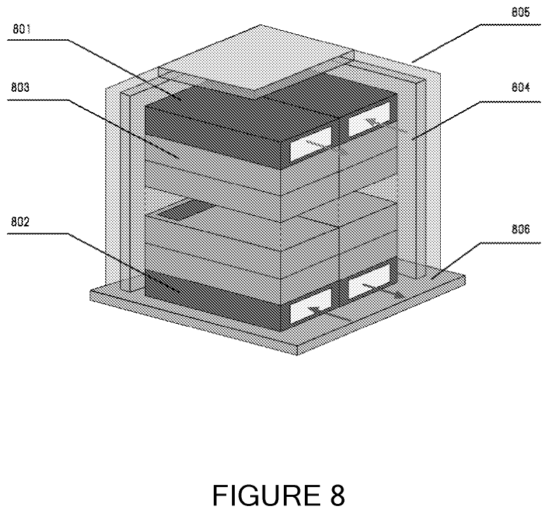

The aspects of the method or system to provide a modular and high-temperature thermal energy storage system which withstands temperature and mechanical conditions according to the present invention, will be described in conjunction with FIGS. 1-8. In the Detailed Description, reference is made to the accompanying figures, which form a part hereof, and in which is shown by way of illustration specific embodiments in which the invention may be practiced. It is to be understood that other embodiments may be utilized and logical changes may be made without departing from the scope of the present invention. The following detailed description, therefore, is not to be taken in a limiting sense, and the scope of the present invention is defined by the appended claims.

The present invention relates to a low-cost, modular and high-temperature thermal energy storage system, with a minimum temperature level of 200° C. FIG. 1 illustrates the 3-D isometric view of the thermal energy storage module with the top view shown as 101 and bottom view shown as 102.

The present invention is able to solve most of the issues encountered previously despite a lower volumetric storage capacity compared to the standard thermocline TES system. The simplicity of design, manufacturing and assembly reduces the implementation time on site and decreases significantly the capital cost. The manufacturing of the modules can be made on assembly lines for further cost reduction. From a thermal point of view, the performance related to the thermal exchanges between the heat transfer fluid and the thermal storage matrix remain the same. However, the different possible configurations (series, parallel or insertion of module filed with phase change materials) provide a tailor-made thermal storage/regenerator adapted to the industrial processes needs with a constant outlet temperature and a reduction of pressure drops. In addition, the design of the present module eliminates most of the mechanical constraints that incurs extra costs, due to material bearing and thermal ratcheting.

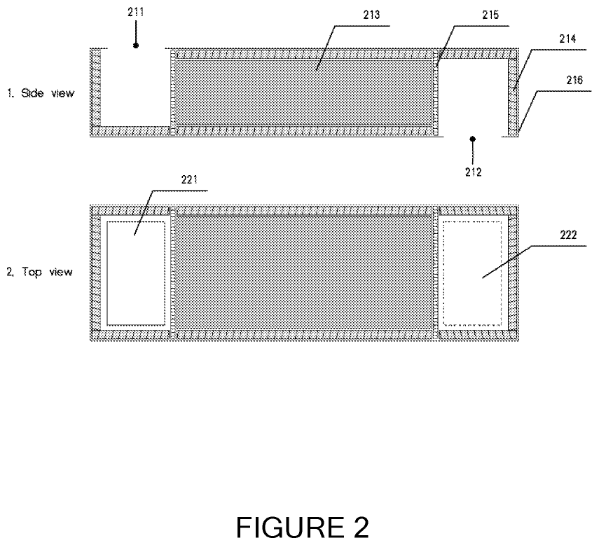

The thermal energy storage module, as illustrated in FIG. 2, consists of 211 and 212 (221 and 222) of the schematic drawing representing the connection of one module with the following module (overhead and below). A specific module is designed to connect the thermal energy storage module and the supply pipe. According to the module charge or discharge steps, the metallic openings allow the heat transfer fluid to flow in one or the other direction. The thermal storage matrix 213, composed of solid filler materials, stores the energy from the hot source. The thermal insulation 214 limits the heat exchange between the different modules. The permeable wall 215 supports the solid filler materials matrix 213 and let the fluid flows through. The casing 216 preserves the mechanical rigidity of the whole.

The thermal storage matrix 213, which represents the key component of the module system, consists of solid materials. The matrix accumulates the thermal energy from the heat transfer fluid during the charge and restores it to the heat transfer fluid during the discharge. This matrix can be made of filler materials with controlled geometry (sphere, cylinder, Raschig rings, etc.) or non-controlled geometry (natural granular material, etc.). It is also possible to use self-supporting materials (checker bricks, honeycomb bricks, etc.). The combination of self-supporting and filler materials is also conceivable. The solid material could be a ceramic (alumina, bauxite, etc.) or natural rocks (basalt, quartzite, etc.) or advanced ceramics made from recycled industrial waste. The thermal insulation 214 and permeable wall 215 contain the volume of the thermal storage matrix inside the module.

The thermal insulation 214 limits the heat exchange between the different modules to insure a high thermal energy storage efficiency. It maintains and contains the thermal storage matrix 213 structurally. A comprehensive range of refractory insulation adapted to the working temperature can be used like calcium silicate. Several types of thermal insulation can be used simultaneously in the thermal energy storage module. The permeable wall 215 holds the thermal energy storage matrix 213 at the inlet and the outlet of the heat transfer fluid. The wall could be a grid, a mesh, supporting beams, etc. The choice of the materials depends on the working temperature range (steel, ceramic, etc.).

The casing 216 insure a structural integrity of the thermal energy storage module, a good airtightness and the connection between the modules. The choice of the materials depends on the working temperature range (steel, ceramic, etc.). In the case of a metallic casing, the thickness of the walls would be few millimeters associated to a structural reinforcement.

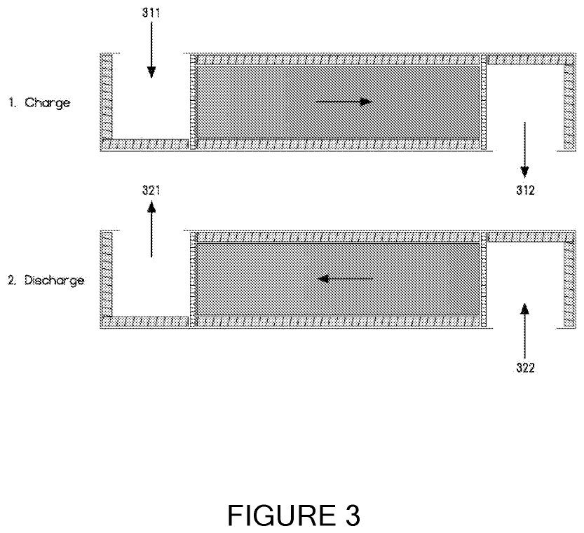

The operation schemes are illustrated in FIG. 3 with the charge scenario and the discharge scenario. During charge, the hot fluid enters through the top opening 311 and creates the thermocline zone which moves progressively through the storage matrix from the left to the right. The cold fluid is extracted from the bottom opening 312. The temperature level of the hot heat transfer fluid is at least 200° C. The heat transfer fluid could be air or flue gas. During discharge, the process is reversed. Air at ambient temperature is inserted from the bottom opening 322. The thermal energy storage at high temperature restores the heat to the colder fluid which moves the thermal gradient from the right to the left. The heat transfer fluid now at high temperature is extracted from the module 321 to supply an energetic process. A ventilation system is installed after the cold part of the module set-up in order to create a gas flow through the whole system. This ventilation system compensates the pressure drop of the thermal energy storage system.

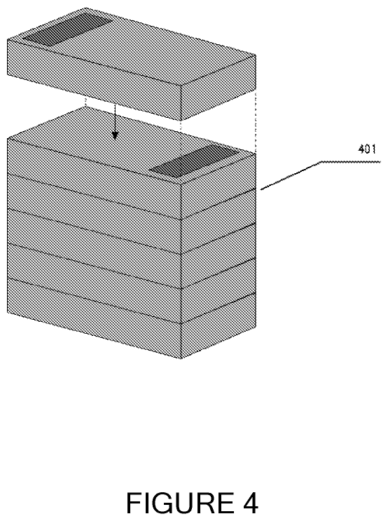

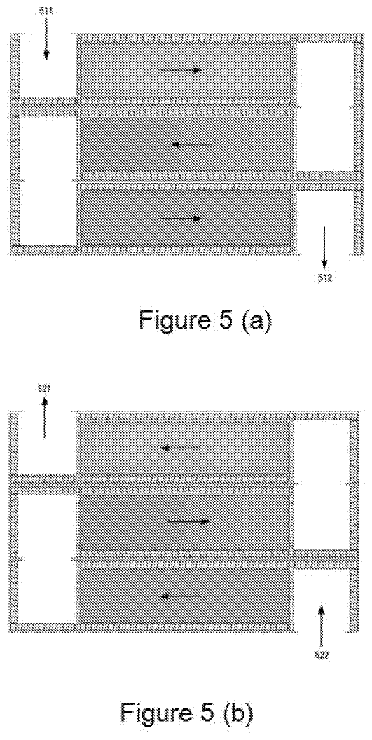

With consideration to the configuration of the thermal energy storage module in accordance with the present invention, the module assembly allows to adapt the storage capacity to the real needs of the energy consumer. As illustrated in FIG. 4, the modules can be stacked on top of each other to increase the thermal energy storage capacity. The stack of modules behaves like a single thermal energy storage unit. During the charge (as shown in FIG. 5A), hot heat transfer fluid enters by the top opening 511, flows through all the thermal energy storage matrixes and exits from the bottom opening of the last module 512. During the discharge (as shown in FIG. 5B), air at ambient temperature enters by the bottom opening 522, flows through every single thermal energy storage matrix and exits from the top opening of the last module 521. The first and last modules of each module stacks are called the fluid inlet/outlet modules. The fluid inlet/outlet modules (depicted as 611, 612, 621 and 622) link the inflow/outflow pipes of the charge/discharge specification with the connected thermal energy storage module. These fluid inlet/outlet modules are specifically designed for each installation. In order to get a constant outlet temperature, some modules filled with a phase change materials matrix can be installed between the fluid inlet/outlet module and the first thermal energy storage module(s).

A method of manufacturing a thermal energy storage assembly and a regenerator using a plurality of thermal energy storage modules comprises the steps of connecting a plurality of thermal energy storage modules between fluid inlet or outlet modules, installing a thermal insulation around the plurality of thermal energy storage modules and the fluid inlet or outlet modules and wrapping an external metallic shell around the thermal insulation, wherein the external metallic shell protects the thermal insulation.

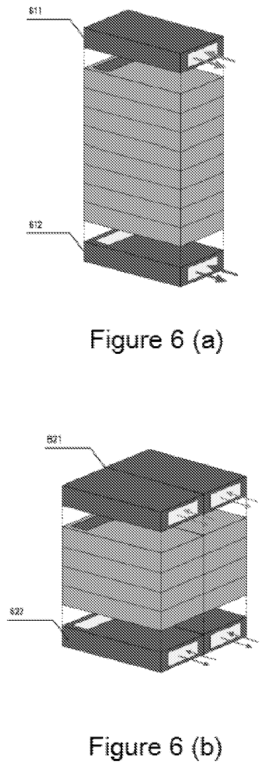

The thermal energy storage modules in accordance with the present invention may be connected together in series or in parallel, as illustrated in FIGS. 6A and 6B. The configurations series/parallel are used to influence the heat transfer fluid distribution. Series configuration reduces the thermocline zone relative thickness of the whole storage system, increasing charge and discharge efficiencies. Parallel configuration reduces pressure losses by reducing fluid velocity in each module line for the same global mass flow. Moreover, during cycling with partial charges and discharges of module in series, thermocline efficiency decreases, while parallel configuration permits to fully charge and discharge a chosen number of modules. Finally, a proper operation of parallel modules with different mass flows and states of charge enables to maintain nominal working condition and control the global outlet temperature during charge and discharge.

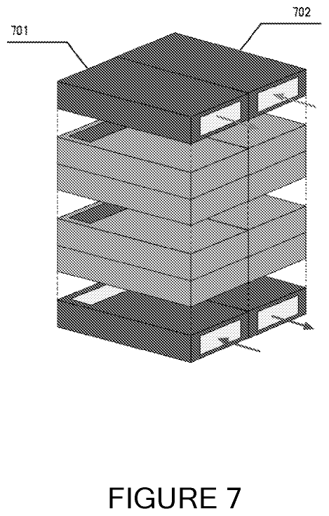

As explained previously, regenerators consist of two chambers through which hot and cold airs flow alternately, one chamber stores the heat from the hot source (charge) while the second chamber transfers the heat to the air (discharge). FIG. 7 represents a regenerator made with the proposed thermal energy storage modules, showing another advantage of parallel configuration (simultaneous charge and discharge). The charge phase is illustrated by 702 and the discharge phase by 701.

Considering the thermal energy storage system in accordance with the present invention, the thermal energy storage assembly and the regenerator configurations consist of fluid inlet/outlet modules 801 and 802. Between these modules, the thermal energy storage modules 803 are connected to each other. To limit the heat losses to the external environment, a standard thermal insulation 804 (rock wool, etc.) is installed around the whole modules stacks. To protect and maintain the thermal insulation, an external metallic shell 805 wraps the system which is built on an insulated concrete pad 806. The association of all these elements is called the thermal energy storage system.

In accordance with the present invention, there is provided a modular and high-temperature thermal energy storage system, which withstands temperature and mechanical conditions. The disclosed thermal energy storage system comprises a thermal energy storage assembly to adapt to storage capacity requirements of an energy consumer comprises a plurality of thermal energy storage modules are stacked on top of each other to increase energy storage capacity, wherein the stack of thermal energy storage modules acts as a single thermal energy storage unit.

Many changes, modifications, variations and other uses and applications of the subject invention will become apparent to those skilled in the art after considering this specification and the accompanying drawings, which disclose the preferred embodiments thereof. All such changes, modifications, variations and other uses and applications, which do not depart from the spirit and scope of the invention, are deemed to be covered by the invention, which is to be limited only by the claims which follow.

1. A thermal energy storage module or regenerator with a constant outlet temperature comprising:
a fluid inlet and a fluid outlet;
a thermal storage matrix composed of solid filler materials for storing energy from a hot source; and
a thermal insulation.

2. The thermal energy storage module or regenerator as per claim 1, wherein a plurality of metallic openings on the fluid inlet and fluid outlet allow for heat transfer fluid to flow in a first direction or in a second direction opposite to the first direction.

3. The thermal energy storage module or regenerator according to claim 1, further comprising a casing which preserves structural rigidity of the thermal energy storage module or regenerator.

4. The thermal energy storage module or regenerator according to claim 3, wherein the casing is made of a rigid and temperature resistant material comprising steel or ceramic.

5. The thermal energy storage module or regenerator according to claim 1, wherein
the thermal storage matrix accumulates thermal energy from the heat transfer fluid during a charge and restores thermal energy to the heat transfer fluid during a discharge.

6. The thermal energy storage module or regenerator according to claim 1, wherein the thermal storage matrix comprises filler materials with controlled or non-controlled geometry.

7. The thermal energy storage module or regenerator according to claim 1, wherein the thermal insulation, mounted around the thermal storage matrix,
ensures high thermal energy storage efficiency by limiting heat exchange between a plurality of thermal energy storage modules; and
further maintains structural rigidity of the thermal storage matrix.

8. The thermal energy storage module or regenerator according to claim 1, further comprising a permeable wall located at first and second ends of the thermal storage matrix, to allow entry of heat transfer fluid through the first end and exit of heat transfer fluid from the second end of the thermal storage matrix.

9. The thermal energy storage module or regenerator according to claim 8 wherein, the permeable wall is made of a temperature resistant material comprising steel or ceramic, and the thermal insulation comprises rock wool.

10. A process of charging and discharging operations of a thermal energy storage system, wherein:
charging results in a cold fluid being extracted from a bottom opening of the thermal energy storage system; and
discharging results in heat transfer fluid at high temperature being extracted from a top opening of the thermal energy storage system.

11. The thermal energy storage system of claim 10, wherein a temperature level of the heat transfer fluid is at least 200° C.

12. The process of charging and discharging operations according to claim 10, wherein charging operation comprises:
allowing entry of a hot fluid through the top opening of the thermal energy storage system; and
creating a thermocline zone which moves a thermal gradient through the thermal storage matrix from a first end to a second end opposite to the first end.

13. The process of charging and discharging operations according to claim 10, wherein discharging operation comprises:
inserting air at ambient temperature through the bottom opening of the thermal energy storage system, resulting in moving a thermal gradient through the thermal storage matrix from a second end to a first end opposite to the second end.

14. The thermal energy storage system according to claim 10, further comprising a ventilation system mounted at the bottom opening of the thermal energy storage system, to compensate for a pressure drop and to create a gas flow throughout the thermal energy storage system.

15. A thermal energy storage assembly capable of adapting to variable storage capacity requirements comprising:
a plurality of thermal energy storage modules stacked on top of each other to increase energy storage capacity, wherein the stack of thermal energy storage modules acts as a single thermal energy storage unit.

16. The thermal energy storage assembly of claim 15, wherein the thermal energy storage modules are connected in a series configuration to reduce relative thickness of a thermocline zone of the whole thermal energy storage assembly, thereby increasing charge and discharge efficiencies.

17. The thermal energy storage assembly according to claim 15, wherein the thermal energy storage modules are connected in a parallel configuration to reduce fluid velocity in each module line, thereby reducing pressure losses.

18. A method of manufacturing a regenerator using a plurality of thermal energy storage modules, the method comprising:
connecting a plurality of thermal energy storage modules between fluid inlet or outlet modules;
installing a thermal insulation around the plurality of thermal energy storage modules and the fluid inlet or outlet modules; and
wrapping an external metallic shell around the thermal insulation, wherein the external metallic shell protects the thermal insulation,
wherein the regenerator is placed on an insulated concrete pad and the external metallic shell wraps the regenerator.

19. The method of claim 18, wherein the regenerator further comprises:
a first chamber to store heat from a hot source resulting in charging operation; and
a second chamber to transfer the stored heat to air resulting in discharging.

20. The regenerator according to claim 18, wherein a parallel configuration of the thermal energy storage modules reduces pressure losses by reducing fluid velocity in each storage module, and allows for simultaneous charging and discharging operations.
